(19) United States
(12) Patent Application Publication
(10) Pub. No.: US 2008/0035700 A1
(43) Pub. Date: Feb. 14, 2008

(54) Quick loading magazine of a coil nailer

(76) Inventor: Chun-Ming Huang, Wufeng Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/502,554

(22) Filed: Aug. 11, 2006

(51) Int. Cl. B25C 5/06

(52) U.S. Cl. 227/120

(57) ABSTRACT

The present invention relates to a quick loading mechanism of magazine of a coil nailer and more particularly to a magazine of a coil nailer that has two corresponding receiving parts possessed on the connection device and the magazine base. Two grooves are implemented inside the receiving parts and two pivot parts are implemented on both sides of the magazine with two flanges provided on the two pivot parts. Through the match of the pivot parts and the flanges with the receiving parts and grooves, a user can rotate the magazine having it positioned slantwise so that the loading port of the magazine will be changed in position from right on the handle to slantwise, then unlock the fixing ridge on the barrel to load nails into the magazine. The mechanism is presumed to have nails being loaded quickly, more conveniently and safely, and the objective of easy operation and safe locking is attained as well.

### FIELD OF THE INVENTION

The present invention relates to a quick loading mechanism of magazine of a coil nailer and more particularly to a magazine of a coil nailer that has its both sides pivotally positioned and axially eccentric to its central axis, through which the magazine loading port can be quickly turned out eccentrically and the objective of easy loading would be attained.

### BACKGROUND OF THE INVENTION

As per general acknowledgement to the structure of loading mechanism of magazine of a coiler nailer, a conventional coil nailer has its magazine fixed at the locations of handle and trigger that makes the operation of nails loading not easy. It is necessary to slant the nailer in a certain degree to load nails, therefore some designs of improvement on the mechanism of magazine of coil nailer have been raised in prior patent applications, which are:

Examples of prior applications described as follows:

An improvement on relevant mechanism of magazine of a coil nailer that has the magazine installed at a central shaft which is located in the center of a seat for coil nails, in which a hollow space is provided and a limit barricade is provided on top of the hollow space, two positioning groove are provided symmetrically on the central shaft positioning along the axial direction of the central shaft; the positioning groove includes an axially positioned groove and several transverse positioning grooves which are provided on the two sides of the axially positioned grooves in a manner of up-down staggered steps; other relevant improvements that were granted with patent and indeed have the magazines of the coil nailer improved yet still have shortcomings to be further improved as follows:

1. Not easy to load in nails: in point of view of structure, the improved coil nailer depicted above has its magazine fixed in the front of the handle, it is necessary to slant the nailer in a certain degree to load nails into the magazine smoothly, which is so sophisticated to get nails loaded.

2. Not easy to operate: in point of view of operation, the improved coil nailer has an overweight magazine cover such that it is not easy for a user to grip the handle firmly during the opening and closing of the magazine cover, to load nails in is not easy and smooth as well, which does not meet the requirement of practicality and convenience in operation.

Being aware of the shortcomings mentioned above, to have the nails loading device positioning quicker, safer and more accurately for attaining optimal practicality, the inventor devotes himself to development of a quick loading magazine of coil nailer that can resolve the technical problems of the shortcomings.

### SUMMARY OF THE INVENTION

The present invention relates to a quick loading mechanism of magazine of a coil nailer and more particularly to a magazine of a coil nailer that has two corresponding receiving parts possessed on the connection device and the magazine base. Two grooves are implemented inside the receiving parts and two pivot parts are implemented on both sides of the magazine with two flanges provided on the two pivot parts. Through the match of the pivot parts and the flanges with the receiving parts and grooves, a user can rotate the magazine having it positioned slantwise so that the loading port of the magazine will be changed in position from right on the handle to slantwise, then unlock the fixing ridge on the barrel to load nails into the magazine. The mechanism is presumed to have nails being loaded quickly, more conveniently and safely, and the objective of easy operation and safe locking is attained as well.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is an exploded view of the present invention;

FIG. 3 is a perspective view of the present invention from another side;

FIG. 4 is a perspective view shows the magazine being opened from another side;

FIG. 5 is a perspective view shows the magazine positioned right on the handle as A; and

FIG. 6 is a perspective view shows the magazine being turned slantwise as B and the magazine cover being opened.

### DETAILED DESCRIPTION OF THE PREFERRED EMBODIMENT

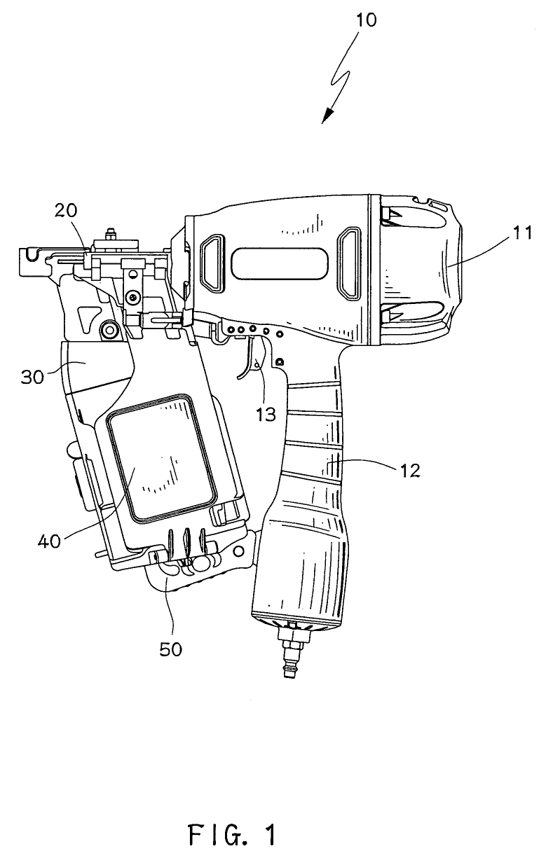

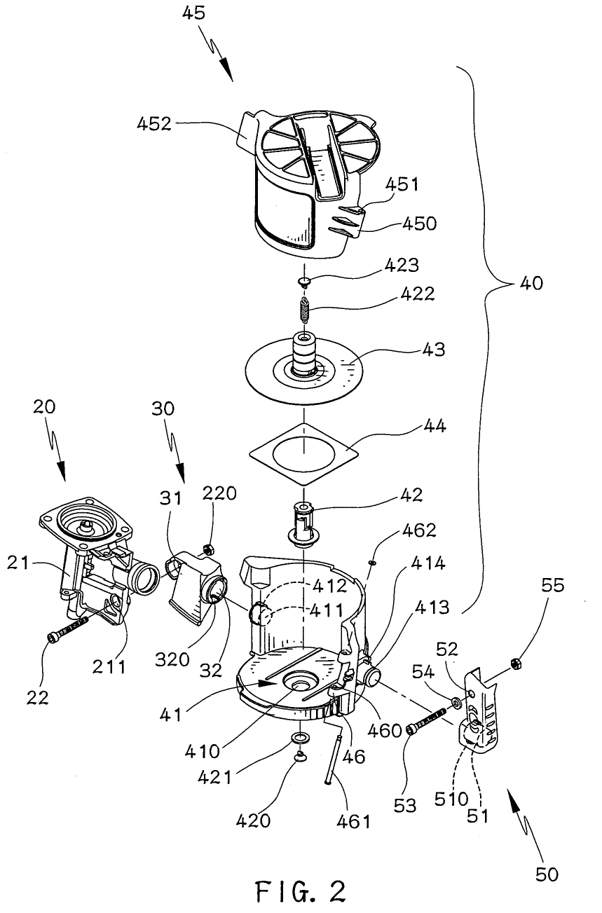

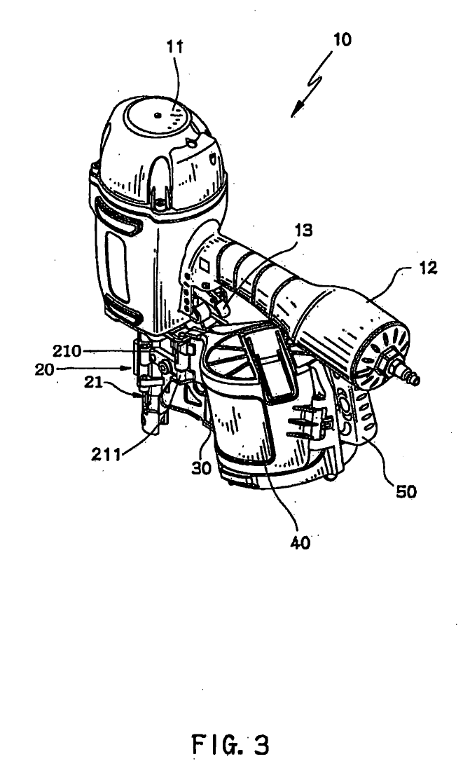

With reference to FIGS. 1 to 4 of the drawings, a quick loading mechanism of magazine of a coil nailer of the present invention is coupled to a coil nailer 10 that includes a body 11, a handle 12, a trigger 13, a nosepiece 20, a connection device 30, a magazine 40 and a magazine base 50. The coil nailer 10 is equipped with the body 11 that is connected to the handle 12, and the trigger 13 is installed on the body 11 near the handle 12. The nosepiece 20 is coupled to the body 11, and the connection device 30 is fastened to the underside of the nosepiece 20. One side of the magazine 40 is pivoted to the connection device 30, and the other side is pivoted to the magazine base 50 that is connected with the handle 12.

The nosepiece 20 is equipped with a cylinder of barrel 21. A lid 210 is implemented on one side of the barrel 21, and a lock hole 211 is implemented on one side of the lid 210 to lock the lid 210 on the nosepiece 20 to complete the operation of nailing. A connecting bolt 22 is engaged the nosepiece 20 and the connection device 30 with a connecting nut 220.

The connection device 30 has a connection hole 31 for connecting to the nosepiece 20 on one end, and a receiving part 32 in a shape of hollow cylinder on the other end. The receiving part 32 has a fillister of groove 320. The receiving part 32 is pivoted to on end of the magazine 40.

The magazine 40 has a nail canister 41 that comprises a disk and an arc plate vertically extended from half circumference of the disk. The nail canister 41 extends a cylindrical first pivot part 411 and a cylindrical second pivot part 413 from two ends of the arc plate, the first and second pivot parts 411 and 413 have two flanges 412 and 414 respectively, and a penetration 410 is provided on the center of the disk. A hollow positioning shaft 42 penetrates through the penetration 410 and is fixed on the nail canister 41 with a first screw 420 and a washer 421, a spring 422 is connected with the first screw 420 and a second screw 423. The positioning shaft 42 goes through a nail holding plate 43. The positioning shaft 42 is elastic and able to adjust the nail holding plate 43 up and down (that is a prior technique will not be described here). The nail holding plate 43 is in shape of disk with extrusion in the center. A gasket 44 is positioned under the nail holding plate 43 and the positioning shaft 42. The magazine 40 includes a magazine cover 45 that has a roller 450 with first fixing holes 451 thereon. A hinge 46 is formed beside the second pivot part 413 of the magazine 40. The hinge 46 has second fixing holes 460 defined thereon on both ends. The hinge 46 and the roller 450 are fastened together by a pin 461 and a split ring 462. A fixing ridge 452 is formed on the magazine cover 45 opposite the roller 450. When the magazine cover 45 is closed on the nail canister 41, the fixing ridge 452 is positioned right between the nosepiece 20 and the barrel 21, the lid 210 will be locked on the nosepiece 20 helping the mechanism being closed firmly and locked in position.

The magazine base 50 is shaped as an L, wherein one end of the L-shaped has a second receiving part 51 with a second groove 510 inside, and the other end has a fastening hole 52. A threaded bolt 53 is gone through a washer 54 and engaged the magazine base 50 and the handle 12 with a nut 55.

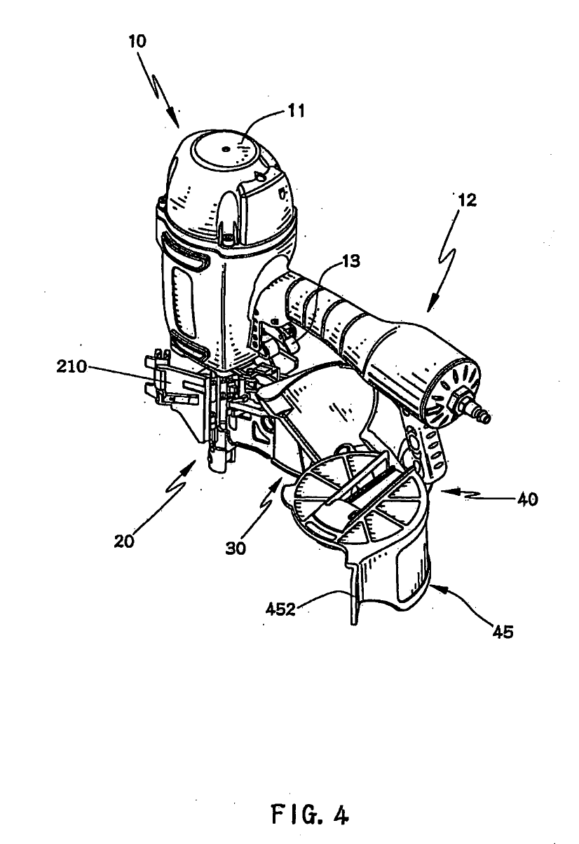

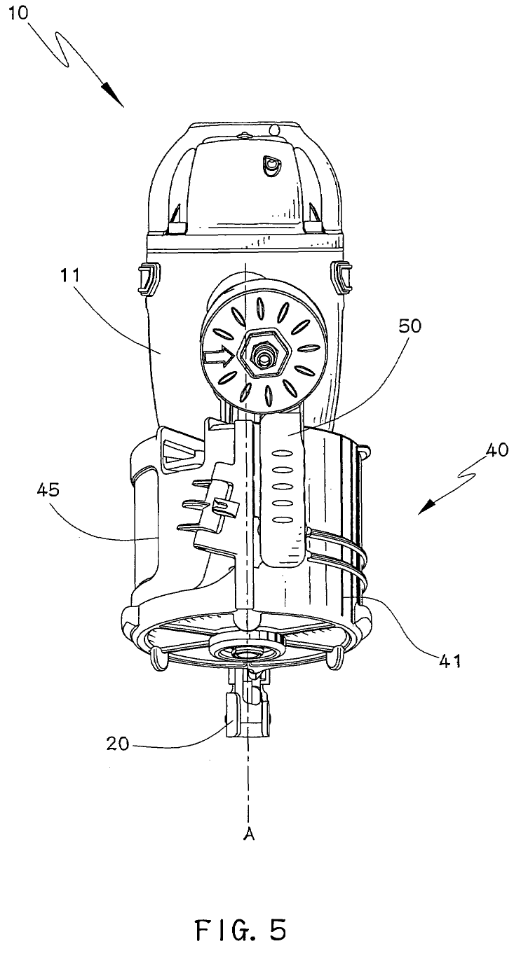

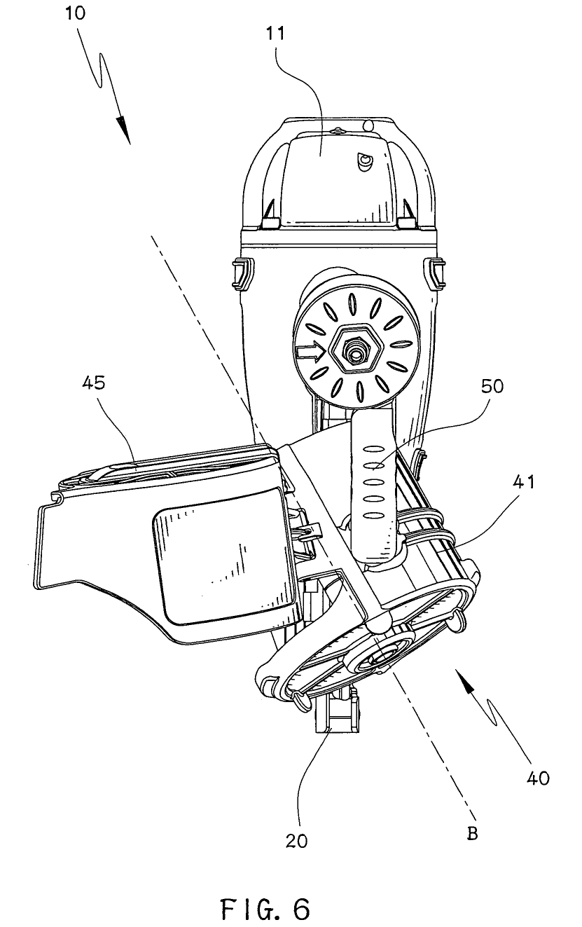

Referring to FIGS. 4 to 6, the quick loading mechanism of magazine of a coil nailer of the present invention includes the nosepiece 20 coupled with the connection device 30. The connection device 30 has the connecting hole 31 for connecting to the nosepiece 20 on one side, and the first receiving part 32 in a shape of hollow cylinder on the other side. The first receiving part 32 has the groove 320 inside. The first pivot part 411 of the magazine 40 is pivoted to the first receiving part 32, and the second pivot part 413 of the magazine 40 is pivoted to the second receiving part 51 of the magazine base 50. When the magazine cover 45 is closed on the nail canister 41, the fixing ridge 452 is positioned right between the nosepiece 20 and the barrel 21, the lid 210 will be locked on the nosepiece 20 helping the mechanism being closed firmly and locked in position, as shown in FIG. 5, A. Additionally, the magazine 40 would be turned by means of the first and second pivot parts 411 and 413 being pivoted to the first and second receiving parts 32 and 51, and constrained by the cooperation of flanges 412 and 414 and the grooves 320 and 510, so that the magazine 40 would be slanted in position on one side of the handle 12, unlock the fixing ridge 452 to load nails into the nail canister 41. After loading, the magazine cover 45 is closed back on the nail canister 41, the fixing ridge 452 is positioned right between the nosepiece 20 and the barrel 21, the lid 210 will be locked on the nosepiece 20 helping the mechanism being closed firmly and locked in position, as shown in FIG. 6, B.

With implementation of the structure described above, the functions as follows would be derived:

1. Easy to operate: with the pivot parts 411 and 413 being pivoted to the receiving parts 32 and 51, and constrained by the cooperation of flanges 412 and 414 and the grooves 320 and 510, so that the magazine 40 would be slanted in position on one side of the handle 12. A user just need to turn the magazine 40 outwardly, then the magazine cover 45 can be opened to load in nails. It is efficient and easy to operate.

2. Accurate and firm loading: with the pivot parts 411 and 413 being pivoted to the receiving parts 32 and 51, and constrained by the cooperation of flanges 412 and 414 and the grooves 320 and 510, so that the magazine 40 would be slanted in position on one side of the handle 12. The magazine cover 45 can be opened to load in nails firmly. After loading, close the magazine cover 45 back to the magazine 40 and push the magazine 40 back to the handle 12, and then the nailing can be operated firmly.

While we have shown and described the embodiment in accordance with the present invention, it should be clear to those skilled in the art that further embodiments may be made without departing from the scope of the present invention.

What is claimed is:

1. A quick loading mechanism of magazine is coupled to a coil nailer, which comprising:
a body;
a handle connected to said body;
a trigger installed to said body near the handle;
a nosepiece coupled to said body;
a connection device coupled to the underside of said nosepiece;
a magazine; and
a magazine base;
the features of the present invention comprising:
said magazine and said connection device including a pivot part and a receiving part respectively, wherein said pivot part and said receiving part having a flange and a groove respectively, with said pivot part being pivoted to said receiving part, and constrained by the cooperation of said flange and said groove, which restricting the slantwise angle of said magazine.

2. The quick loading mechanism of magazine of a coil nail as claimed in claim 1, wherein said connection device includes said receiving part.

3. The quick loading mechanism of magazine of a coil nail as claimed in claim 2, wherein said receiving part includes said groove.

4. The quick loading mechanism of magazine of a coil nail as claimed in claim 3, wherein said receiving part may include several said grooves.

5. The quick loading mechanism of magazine of a coil nail as claimed in claim 3, wherein said groove is in shape of fillister.

6. The quick loading mechanism of magazine of a coil nail as claimed in claim 1, wherein said magazine includes a nail canister.

7. The quick loading mechanism of magazine of a coil nail as claimed in claim 1 or 6, wherein said nail canister includes several hollow cylindrical pivot parts.

8. The quick loading mechanism of magazine of a coil nail as claimed in claim 7, wherein said pivot part includes said flange.

9. The quick loading mechanism of magazine of a coil nail as claimed in claim 7, wherein said pivot part is in shape of shaft and has several said flanges.

10. The quick loading mechanism of magazine of a coil nail as claimed in claim 1, wherein said flange is in shape of salient.

11. The quick loading mechanism of magazine of a coil nail as claimed in claim 1, wherein said magazine base has a receiving part relative to said connection device.

12. The quick loading mechanism of magazine of a coil nail as claimed in claim 1, wherein said pivot parts of said magazine are pivoted with said receiving parts respectively.

13. The quick loading mechanism of magazine of a coil nail as claimed in claim 3 or 8, wherein said flange is matched with said groove.
